(19) United States
(12) Patent Application Publication
(10) Pub. No.: US 2009/0293785 A1
(43) Pub. Date: Dec. 3, 2009

(54) COMBUSTION SYSTEM WITH CELLULAR CHAIN GRATE

(76) Inventor: James GALLANT, Kingsville (CA)

Correspondence Address: BLANK ROME LLP, WATERGATE, 600 NEW HAMPSHIRE AVENUE, N.W., WASHINGTON, DC, 20037, US

(21) Appl. No.: 12/477,653

(22) Filed: Jun. 3, 2009

Related U.S. Application Data
(60) Provisional application No. 61/058,316, filed on Jun. 3, 2008.

(51) Int. Cl. F23H 11/18; B65G 17/40

(52) U.S. Cl. 110/329; 198/853

(57) ABSTRACT

A chain grate for a combustion system is disclosed, comprising a continuous belt of connected links. The links have a generally boxlike configuration open to below and comprise a substantially solid upper surface, and at least one downwardly projecting wall. At least some of said links comprise at least one vent open to said surface. The grate comprises an array of substantially isolated cells open to below and a substantially continuous upper surface defined by said links. The vents permit combustion gas to travel from the interior of said cells to said surface. The links are joined together in a linear array by a hinge structure at the opposing ends of the links. The grate is intended to be supported by a bed which includes one or more plenums which have a flat upper surface for supporting the grate. The grate rests upon the flat surface to effectively form a sealed, cellular structure defined by the interior spaces within the link bodies. Openings in the upper surface may be aligned with the vents in the links, thereby effectively permitting zonal distribution of combustion gasses across the grate.

### CROSS-REFERENCE TO RELATED APPLICATION

This application claims the benefit of U.S. provisional application No. 61/058,316, filed on Jun. 3, 2008.

### FIELD OF THE INVENTION

The present invention relates to equipment and methods for combustion systems, wherein combustion is improved and controlled by directing a flow of gases through the combustion bed.

### BACKGROUND OF THE INVENTION

Gasification-based combustion systems rely on a supply of gases channeled in a controlled fashion through the combustion bed. The gas usually consists of air, which may consist of a mixture of outside air and recirculated combustion air. Some modern combustion systems provide a combustion bed which is divided into zones in which the combustion conditions can be varied for optimal combustion efficiency. The combustion bed of such systems may comprise a conveyor, such as a chain grate which forms a continuous belt to convey the combustible material in a linear path through the elongate combustion chamber. As the material combusts, it can be desirable to alter the oxygen content, gas velocity or other conditions that are delivered within the combustion chamber.

Examples of prior art systems which provide multiple combustion zones are believed to include the following patent documents: Canadian patent no. CA2466957 to Orbeck et al; Japanese patent document no. 05060803; Japanese patent abstract no. 2001138601; Japanese patent document no. 58175759; and Japanese patent document no. 54065423.

Prior art systems are believed to suffer from several drawbacks, including an inability to precisely control the gas flow conditions delivered to the fuel, and an inability to ensure that essentially all of the combustion gas is directed through the bed in a controlled fashion without undesired escape of an excessive amount of the gas into other zones of the bed or bypassing the combustion areas entirely. As well, most prior art systems are predicated on the idea that the fuel must be turned or mixed in order to ensure complete combustion throughout.

One type of known combustion system includes a chain grate as the supporting surface for the fuel. The chain grate has openings to permit gas to flow into the combustion bed from a plenum beneath the grate. Such openings can become clogged with ash and other debris, and it is desirable to provide a self-cleaning function for the openings. Chain grates having self-cleaning features have been suggested in the prior art, including U.S. Pat. No. 1,486,987 to Polster and U.S. Pat. No. 1,713,322 to Bennis. Typically, such self-cleaning occurs when the openings within the grate widen as the grate passes over end rollers or is otherwise bent from its normal horizontal planar disposition. However, it has heretofore been difficult to combine such self-cleaning features with the need to provide a chain grate wherein the upper surface is essentially sealed against gas transmission except for specific and limited openings within the grate.

### SUMMARY OF THE INVENTION

The present invention has as an object the provision of an improved combustion system and components thereof, as well as improved combustion methods. One object of the invention is to address at least some of the drawbacks identified above, and to provide a combustion system that operates efficiently and permits combustion to occur in a controlled fashion.

According to one aspect, the invention consists of a chain grate for a gasification combustion system, comprising a continuous belt composed of connected links. Each link comprises a generally box-like configuration open to below, with a substantially solid upper surface for supporting a combustible material with front, rear and side edges and a wall or skirt projecting downwardly from the upper surface. The skirt may extend downwardly from adjacent the side edges and either the front or rear edge. The grate comprises an array of essentially isolated cells open to below and a substantially continuous upper surface defined by the links. The links include at least one vent to discharge gas from said interior space to a combustion fuel disposed on said surface.

Preferably, the links are connected together end to end in a linear fashion by interconnected hinge members, and the vent is located at or near said hinge member. The vent may comprise opposed recesses located at or adjacent to each respective hinge member configured to form opposing sides of the vent when the links are co-planar and to diverge from each other to expand the size of said vent as said links pivot relative to each other into a non-co-planar relationship. This provides a self-cleaning function that permits ash and other materials that may have clogged the vent to fall free of the vent as the grate passes around a roller and the vent is opened.

Preferably, the links are configured such that the front and rear edges of said links abut each other to substantially seal the space between adjacent links when the links are disposed in a planar configuration.

In another aspect, the link undercarriage includes a first hinge member adjacent the front edge of the upper plate and a second hinge member adjacent the rear edge, and a recess within the upper plate which is open to the rear edge. The first hinge member comprises a hinge block at the first end of the link, which pivotally engages a second hinge member located at the second end of an adjacent link. The second hinge member comprises opposed spaced apart protrusions configured to engage the hinge block therebetween. The vent may be incorporated into the hinge structure, in that the hinge block may include a groove open to the surface thereof which is configured to align with a notch within the upper plate of an opposing link. Preferably, the groove is disposed at an angle which departs from the vertical when said link is horizontal. For example, the pin block may be generally semi-cylindrical with a flat upper surface configured for the upper surface of an adjacent link to overlap said flat upper surface, with the groove being disposed within an upper curved face of said pin block.

Alternatively, the vent may be provided elsewhere within the link body so as to vent gases from the interior space of the link body to the overlying combustion bed.

The side edges of the links may overlap to form a substantially continuous surface consisting of multiple linear rows of links. In a preferred embodiment, the pivot joint includes a pair of opposed pins protruding laterally from the end walls of said pin block, said pins being received within recesses within said plates which face each other in the opposed plates. Within adjoining links, each groove and recess are in overlapping aligned relationship at said flat upper surface of said pin support.

The links have a generally planar lower edge such that when the links are disposed on a flat bed, the links for an interior space that is substantially sealed apart from vents.

According to one aspect, the chain grate comprises vents defining a matrix across the length and breadth of the grate. Combustion gas is supplied under pressure into the cellular array defined by the links. Since essentially the sole pathway for the escape of pressurized gas is through the vents within the chain grate, one may control combustion by controlling the characteristics of the gas being vented at locations throughout the grate surface. As well, by moving the grate in a controlled fashion within the combustion chamber, the matrix of vents provides a convenient way to pulse the delivery of gas.

The chain grate as described above may be incorporated within a combustion system. The system includes a combustion chamber, within which are provided a support frame, first and second rollers at opposing ends of said frame journalled for rotation relative to said frame, a bed for supporting a chain grate between said rollers, and a chain grate as described above extending around said rollers and supported by said bed, and drive means to rotate one or both of the rollers. A source of combustion gas is also provided to deliver gas under pressure to the system. The bed extends substantially the entire space between the rollers, and includes a plenum structure composed of one or more individual plenums, and a flat upper surface to support the grate and permit the grate to slide across the bed. The upper surface is substantially solid apart from perforations which communicate with the interior plenum(s) to discharge combustion gasses. The hollow interior of each link is substantially sealed when supported by the bed, thereby forming an array of substantially isolated cells. The perforations are located so as to align with the hollow interior spaces of the links as the links traverse the bed, so as to discharge combustion gasses into the interior portions as the links traverse the bed. The vent within the upper plate of the links permits this gas to exit the grate to feed the combustion process occurring on the grate. The links may also be located an in a non-aligned position as the grate traverses the bed, in which the perforations within the bed do not open into the link interior spaces and the combustion gases are effectively prevented from discharging. This permits the fuel bed to settle around the openings in preparation for gas flow to resume once the openings return to the aligned position. Alternatively, the matrix of openings through the upper surface of the plenum may be staggered between adjacent rows to prevent the simultaneous obstruction of delivered combustion gases over the full width of the conveyor. In this manner, only every second or third chain row will be blocked at any given time. The grate may be moved in a continuous fashion or in a discontinuous fashion to vary feed rate and residence time of the fuel.

In one version, the upper surface of the bed comprises a layer of refractory brick fabricated from a suitable abrasion-resistant material to permit the grate to slide across the layer with minimal wear.

The source of combustion gases delivers pressurized gas to the plenum(s) within the bed. Multiple plenums may be provided to permit delivery of multiple gas streams which can vary in oxygen content or other conditions or parameters. For example, the gas may differ in its mixture of outside air and recirculated gas from the combustion chamber, by delivering gas from a common source and mixing therein varying amounts of recycled combustion gas.

According to another aspect, a method of combustion fuel is provided wherein the system as described above it utilized. According to one aspect of this method, after the fuel is deposited upon the grate, each piece of fuel may remain essentially mechanically untouched and unmoved until it is essentially fully combusted into ash. It is believed that this may be achieved by permitting the fuel bed to remain undisturbed and bringing the combustion air to the fuel using the above system wherein each link has its own air injection port and the entire grate effectively comprises an air distribution plenum.

Having thus described the invention in general terms, the invention will be further illustrated by reference to particular embodiments of the invention. These embodiments are not intended to limit the scope of the invention, which is described in full in the present patent specification as a whole, including the claims. It will be further seen that directional references employed throughout this specification and claims, such as “upper” and “side,” are intended to refer to the chain grate components in their normal horizontally disposed position in which combustion fuel may rest on the grate, and the other components in a position suitable for the system to be operated in its normal fashion.

### BRIEF DESCRIPTION OF THE DRAWINGS

FIG. 1 is a perspective schematic view of a combustion chamber according to the present invention, wherein the chain grate and other components have been removed for clarity.

FIG. 2 is a detailed view showing a portion of the combustion chamber of FIG. 1.

FIG. 3 is a perspective view of a portion of a plenum structure and bed for supporting a chain grate, wherein a portion of the bed has been removed to show internal structure.

FIG. 4 is a perspective view of a portion of a chain grate and support bed, showing the grate partially extending about an end roller.

FIG. 5 is a perspective view of two pivotally connected links of a chain grate according to the invention.

FIGS. 6A-6H are perspective and plan views of a link of a chain grate according to the invention.

FIG. 7 is a perspective view of a portion of a chain grate according to a second embodiment of the invention.

FIG. 8 is a perspective view of a link according to the second embodiment.

FIG. 9 is a further perspective view of the second embodiment.

### DETAILED DESCRIPTION

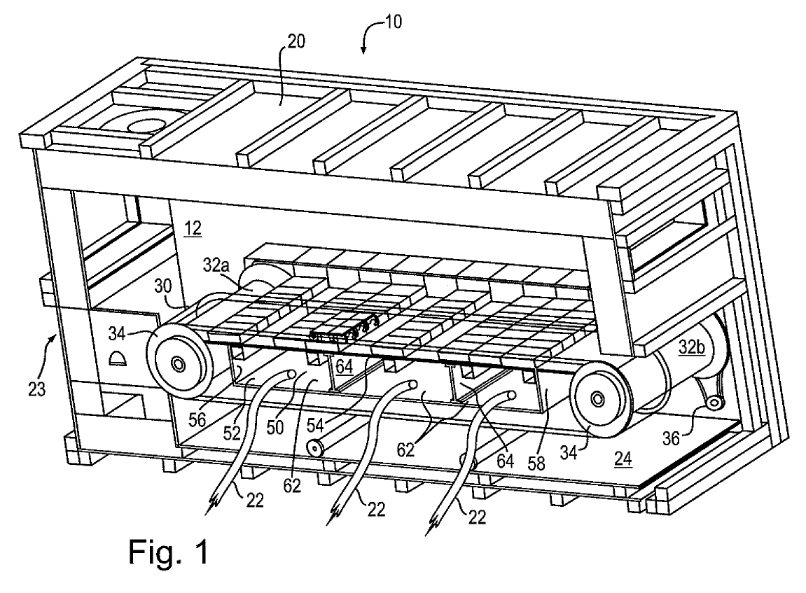

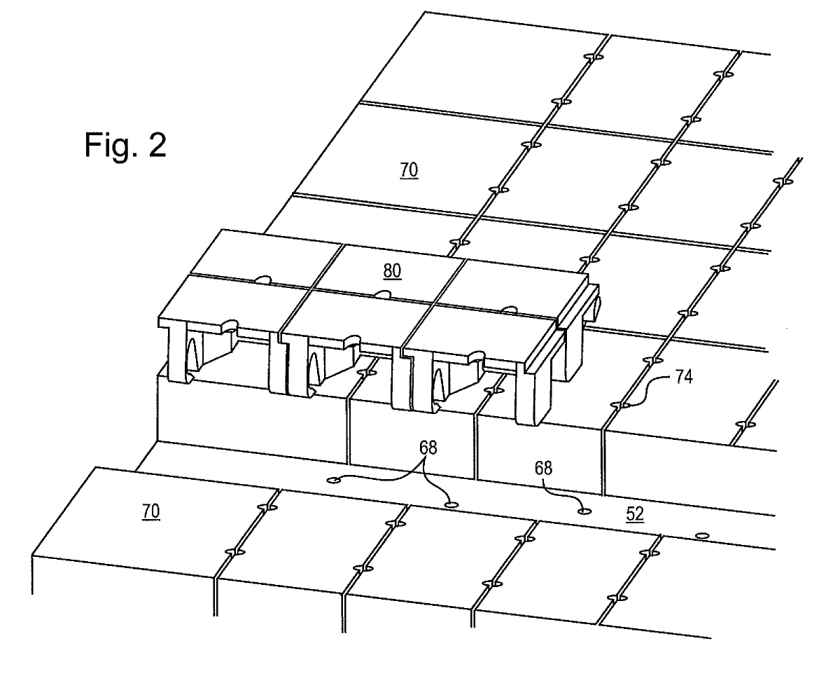

Referring to FIGS. 1 and 2, the present invention relates to a combustion system 10 and its related components and inputs. The system 10 includes a combustion chamber 12, a delivery system (not shown) to deliver combustible material to the combustion chamber. Additional system components include a source 22 of pressurized combustion gases for delivery to the interior of the combustion chamber, and associated blowers, power modules and control system (not shown). In general, the present invention may rely on conventional combustion system components such as the above.

The interior of combustion chamber 12, seen in FIG. 2, includes an elongate housing 20 having a forward end 23 which receives combustible material into the chamber interior 12. Housing 20 is fabricated from material(s) suitable for combustion chambers of the present type. Chamber 12 houses a support structure 24 which supports components described in detail herein. Within housing 20, fuel is deposited by conventional means onto a chain grate 30, seen in transparent view in FIG. 1, consisting of a continuous belt. Chain grate 30, discussed in greater detail below, supports combustible material and permits such material to be transported from the forward to the rearward ends of the chamber as combustion occurs.

Chain grate 30 constitutes a continuous belt which rotates between a pair of belt rollers 32, which define the respective ends of the rotating belt. Belt rollers 32 traverse the interior of housing 20 and are journalled for rotation with an axis of rotation transverse to the long axis of housing 20. Belt rollers 32 possess raised flanges 34 at either end thereof to hold chain grate 30 in place directly over rollers 32. One or both belt rollers 32 are driven by drive means 36, which are shown schematically, and may constitute any suitable means for rotating the roller(s) in a controlled fashion. For convenience of description, the portion of the chain grate that at any given moment moves from the forward roller 32a to the rear roller 32b and which supports the combustible fuel, is referred to as the “active portion”. The portion which at any given time is returning to the forward roller, and is located beneath the forward portion, is referred to as the “return portion.”

An array of idler rollers 38 support the belt from below. The idler rollers are journalled for rotation about an axis parallel to belt rollers 32, but located on a plane below the belt rollers. The idler rollers are positioned to support the return portion of the chain grate 30 and to reduce mechanical stresses on the chain grate. Idler rollers 38 are preferably freewheel (non-driven), but it is contemplated that for some applications they may be driven. The ends of idler rollers 38 include raised flanges 40 which maintain the grate 30 in position as it passes over rollers 38.

A plenum structure 50 inside the chamber is located between belt rollers 32 to underlie and support the upper, fuel-bearing portion of grate 30. Plenum structure 50 extends lengthwise substantially for the entirety of the space between belt rollers 32, and spans in width the entire width of grate 30, which constitutes substantially the width of the chamber 12. Plenum structure 50 comprises a hollow substantially sealed boxlike structure formed from steel plates or the like, having upper and lower plates 52 and 54 spaced apart from each other and front, rear and side walls 56, 58 and 60. The interior of the plenum structure is divided into multiple compartments 62 which are sealed from each other to form a plurality of individual air plenums extending laterally across the plenum structure. Compartments 62 are divided from each other by vertical divider walls 64. The upper plate 52 of the plenum structure 50 includes multiple perforations 68 to permit pressurized gases to escape from each compartment 62 for discharge towards the overlying chain grate (see FIG. 2). Perforations 68 are located in a series of rows extending widthwise across the plate and columns extending length-wise, forming a regular array of perforations. Perforations 68 are configured to permit a stream of gases from within each of the internal compartments to pass through the chain grate in a manner to be described below.

Each of the individual plenum compartments 62 within the plenum structure 50 is supplied with combustion gas from source 22. Compartments 62 are preferably supplied with gas independently of each other, although the supply may originate from a common source, such that the gas pressure and other conditions within each compartment may be independently controlled. Gas source 22 consists of any suitable means to supply combustion gas in a controlled fashion. For example, the combustion air flow may be controlled with a conventional system of automatic proportioning dampers, such that a single underfire blower delivers a variable blend of fresh air and recirculated flue gas to each compartment. The appropriate blend in each case is determined by the combustion chamber oxygen concentration and temperature.

As seen in FIG. 3 (wherein a portion of the bed has been cut away to show internal structure), the top plate 52 of the plenum structure 50 supports a layer of perforated ceramic refractory tiles 70 fully covering upper plate 52. Tiles 70 may be fastened to the top surface with any suitable fastening means such as refractory cement or mechanical fasteners, or alternatively they may be retained by the pressure of the overlying belt. Tiles 70 are composed of a highly abrasion-resistant refractive material, which permits the active portion of the chain grate to slide over the tiles. Tiles 70 have a smooth and flat upper surface, which both reduces friction and wear, and also permits an effective seal between the bed and the chain grate 30 disposed on and supported by tiles 70. In one version, tiles 70 are composed of cast, high alumina ceramic bricks. Tiles 70 are arranged in aligned rows and columns so as to form a regular matrix-like array across the width and length of the upper plate of the plenum structure. Openings 74 are provided within the layer of tiles 70 to permit combustion gases discharged from the perforations 68 within the plenum structure 50 to pass through the layer of tiles 70. Openings 74 are formed by vertical grooves set into the sidewalls of tiles 70, such that grooves of facing sidewalls are aligned. The openings are located directly above the perforations within the upper plate of the plenum structure, and form an identical array, such that any gas discharged through a perforation 68 may flow through a corresponding opening 74 within the layer of tiles 70.

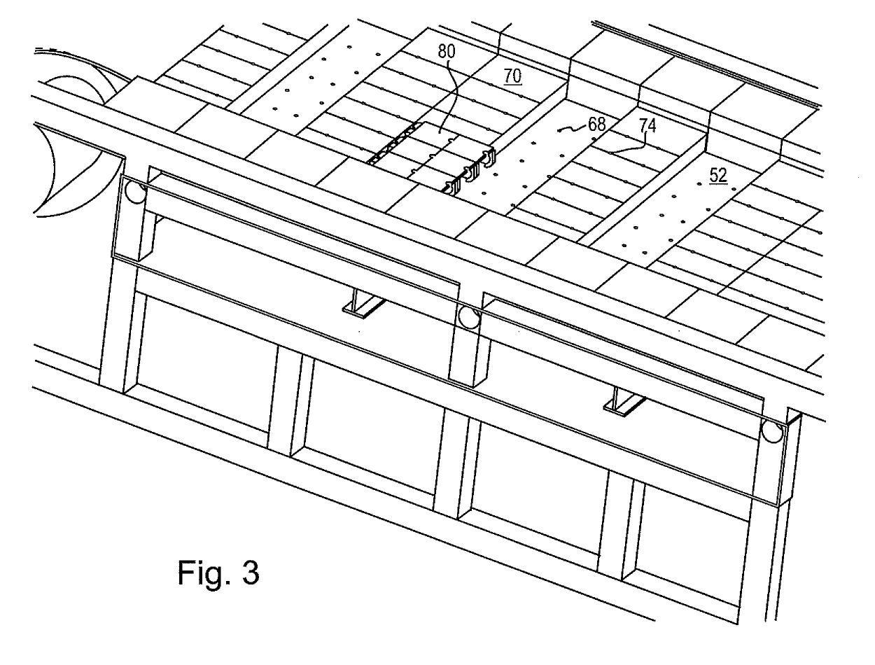

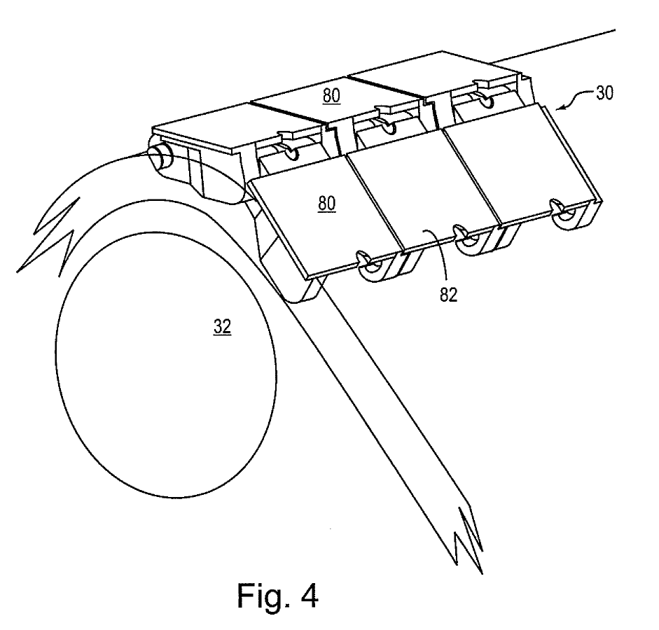

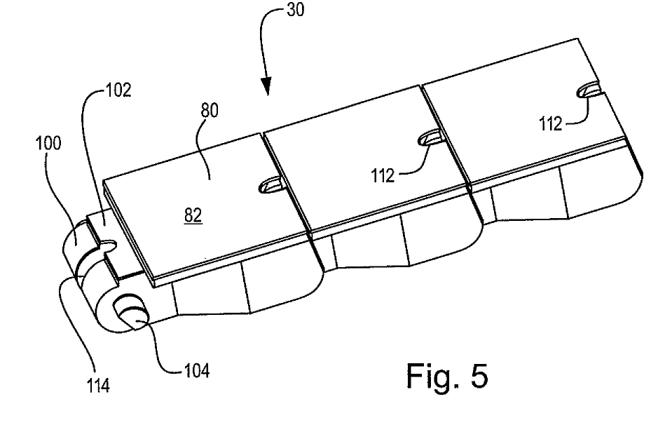

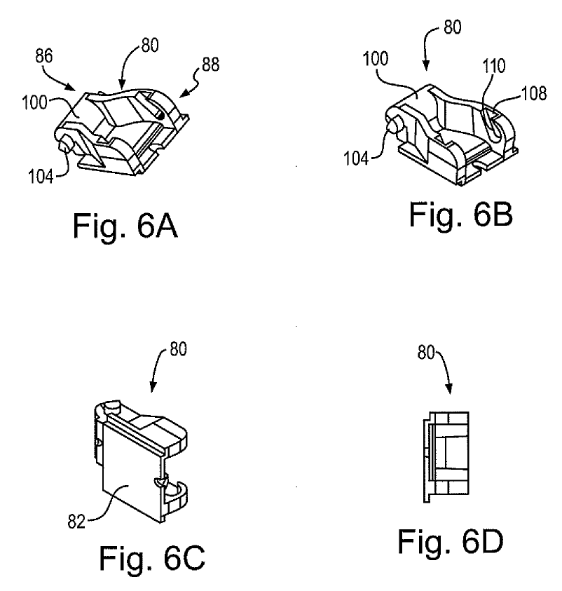

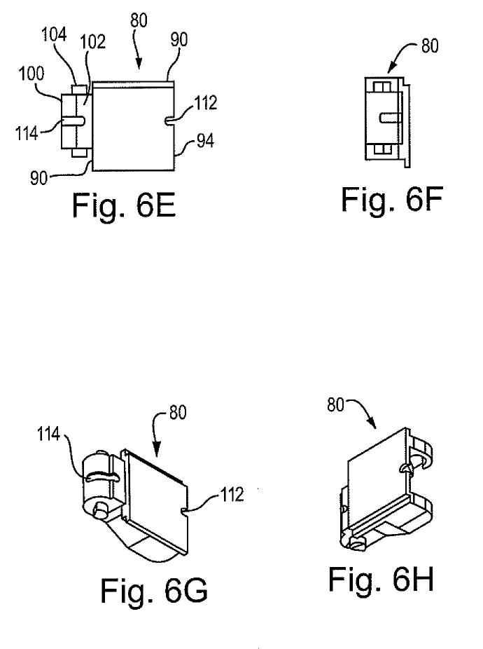

Chain grate 30 is composed of a linear array of rectangular links 80, seen more particularly in FIGS. 4, 5 and 6A-6H. The individual links 80 are pivotally joined together at their front and rear edges to permit them to form a flexible belt able to bend around the belt rollers 32. The array of links consists of at least one column of connected links 80. Preferably, the array is composed of multiple columns connected together in side by side relation, with the links 80 in the individual columns being aligned with each other.

Links 80 each consist of a generally rectangular body having a flat rectangular upper plate 82 which forms a support surface for the combustible material, and an undercarriage that includes sidewalls 84 along the lateral sides of link 80 and front and rear hinge members 86 and 88. Upper plate 82 is rectangular with straight side, front and rear edges 90, 92 and 94 such that when multiple links 80 are co-planar, abutting plates 82 effectively form a continuous surface which effectively seals against gas leakage except at the gas vents, described below. The sidewalls 84 and hinge members 86 and 84 extend downwardly from the periphery of upper plate 82 forming a hollow space 96 beneath the upper plate. In combination, the sidewalls and hinge members form a skirt which partially surrounds the periphery of the link 80 and has a flat and co-planar lower rim 98. The links 80 when contacting and lying flat on an underlying flat bed thus effectively form a sealed compartment or cell defined by the hollow space 96 formed by the link body and the layer of tiles 70. In one version, the dimensions of the upper plate may be about 5″×5″ across, and ¼″ in thickness, and the overall height of the link is about 2″, although it is evident that these dimensions are merely illustrative. Links 80 are fabricated of any material suitable for the conditions that will be encountered; in one version, they are composed of a one piece high nickel/chromium steel alloy casting. It is also contemplated that other alloys may be used, and also that links 80 may be assembled from separate components with, optionally, the upper plate 82 comprising a different material from the other portions of the links.

The hinge components 86, 88 of links 80 include a pivot pin block 100 at the front of the link. The block consists of a solid semi-cylindrical member having an elongate axis which is transverse to the direction of travel of the link. Pivot block 100 has a flat upper surface 102 which is downwardly stepped from the upper surface of the upper plate 82. Upper surface 102 of pivot block 100 supports the upper plate 82 of an adjoining link 80 and provides an area of overlap to minimize gas leakage between adjacent plates 82. Block 100 does not extend the full width of the link, but is inwardly stepped. A pair of pivot pins 104 protrude laterally outwardly from the end walls 106 of block 100. The opposing hinge member consists of a pair of pin-receiving recesses 108 set into the inwardly-facing surfaces of sidewalls 84, at a location towards the rear of link 80. Recesses 108 consist of mirror-image grooves that face each other, configured to permit pivot pins 104 from an adjoining link 80 to be inserted therein. Recesses 108 include a circular region 110 at their upper ends, which are shaped to retain pivot pins 104 therein without inadvertent release. When pivot pins 104 are retained within recesses 108 of an adjoining link, the links 80 are connected together such that their upper plates 82 form a substantially continuous flat surface. The connected links 80 are effectively hinged together such that they may pivot about an axis transverse to the direction of travel of the belt 30. The degree of pivoting must be sufficient to permit the grate 30 to travel around the belt rollers 32. As the links 80 pivot relative to each other, the upper plates 82 diverge from each other.

Where sidewalls 84 support opposing recesses 108, sidewalls 84 are parallel to each other and aligned with the side edges of the upper plate 82. Forwardly of this region sidewalls 84 angle inwardly to merge with end walls 106 of pivot blocks 100, which are inwardly stepped from the side edges of the plates 82 to permit the pivot pins 104 to fit within the rear hinge member.

The links 80 are configured to provide a self-cleaning vent 110 at their hinge regions. Vent 110 consists of two openings 112, 114 within the upper plate 82 and the pivot block 100 of the front hinge member, which align with the corresponding openings in abutting links. First opening 112 consists of a notch within upper plate 82 of each link which provides an opening through the upper plate 82 when multiple links are joined together with their respective upper plates contacting each other. Preferably, notch 112 is centrally located within the rear edge. The opening 114 within the pivot block 100 consists of a groove recessed into the curved surface of the cylindrical pivot block. Groove 114 extends from the flat upper surface of pivot block 100, to a location about halfway down the surface of the pivot block. The floor of groove 114 follows a similar curvature to the surface of pivot block 100. When two connected links are in a co-planar relation with each other, vent 110 provides a curved pathway with a relatively small opening located at the hinge region of adjoining links. As the links travel around the belt rollers and the upper plates 82 separate from each other, vent 100 is effectively widened and forms less of a curved pathway, thereby permitting ash and other material which may have fallen into the vent to self-clear and drop downwardly. In one version, the vents are approximately 10 mm in diameter when the links are co-planar, and widen to about 25 mm in diameter as they pass around the belt rollers. However, such dimensions are merely illustrative and may be varied depending on the intended use of the system, as well as other considerations.

It is also contemplated that additional openings within the link may be provided, either by way of additional vents at the hinge region thereof or elsewhere within the link body.

Links 80 are preferably configured to permit overlapping of the upper plates 82 with recessed portions of adjacent links located alongside each other in a lateral direction. For this purpose, the upper plate 82 protrudes laterally outwardly past the sidewall on one side of the link. At the opposed lateral side of the link, the upper plate is inwardly stepped from the sidewall by the same amount as the outward protrusion of the opposed sidewall. The inward step 120 forms a support surface for the outwardly-protruding portion 122 of an adjacent link, thereby permitting the adjacent links to overlap and further seal the space between the links against gas leakage.

The links are retained in a close side-by-side relationship by flanges 34 and 40 on the belt and idler rollers 32 and 38, which effectively hold the belt together in its lateral dimension. Adjacent links may be affixed to one another using mechanical means, such as an array of alloy rods (not shown) extending the full width of the conveyor, passing through adjacent links.

The lower face of each link 80 constitutes a flat planar surface 98 which when resting on the underlying refractory brick or tile 70 results in a substantially gas-tight seal. As mentioned, the interior of the link 80 consists of a hollow space 96 open to below, which when resting on the underlying bed forms a substantially sealed cell. The only passageways entering and exiting this space are composed of the openings 74 within the tile bed and vents 100 within links 80. Vents 110 effectively form a matrix covering substantially the entire surface of the chain grate 30. Preferably, the spacing of all of openings 74 and 110 can be aligned, and can also be aligned with perforations 68 within the upper plate of the plenum structure 50. Alternatively, the matrix of openings 68 through the upper surface of the plenum may be staggered between adjacent rows to prevent the simultaneous obstruction of delivered combustion gases over the full width of the conveyor.

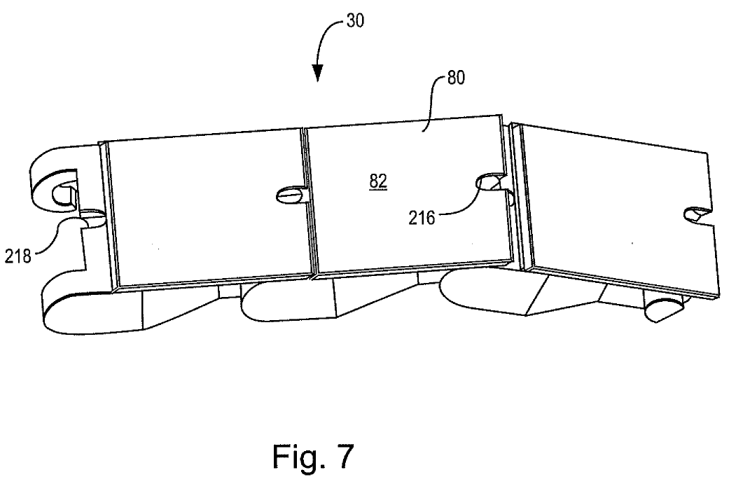

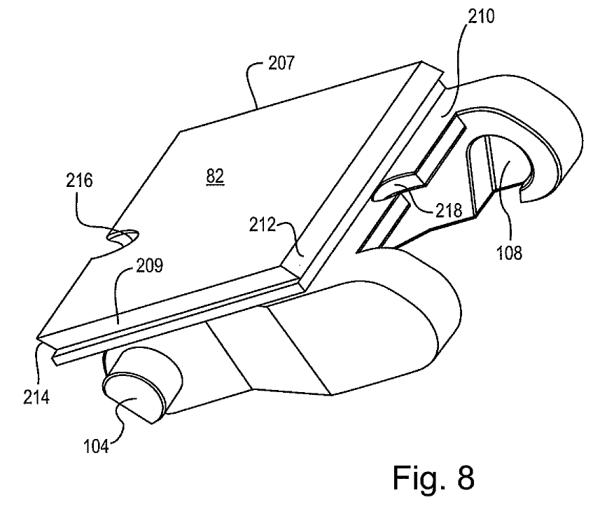

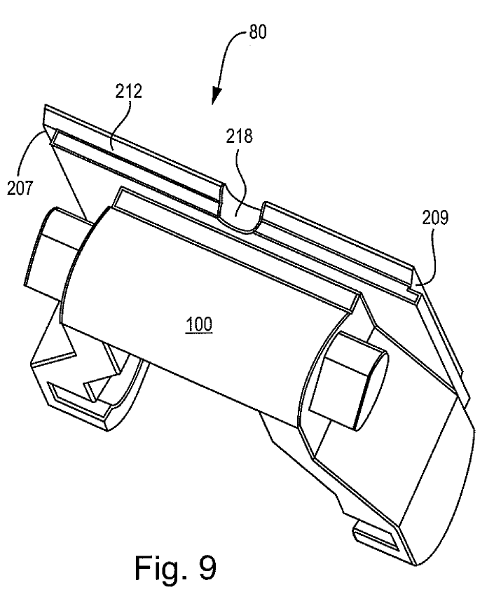

According to another embodiment shown in FIGS. 7, 8 and 9, one end of the upper plate 82 of link 80 projects lengthwise beyond one end of the undercarriage, to form a protruding shelf 200. The opposed end of the upper plate is inwardly stepped from the undercarriage to form a recessed shoulder 210, such that the shelf 200 and shoulder 210 of adjacent links overlap each other. The opposing longitudinal end walls 212 and 214 of the upper plate 82 are chamfered or bevelled so as to permit adjacent links to overlap each other. A vent 216 is formed by aligned scallop-shaped recesses 218 within the floor 210 and shelf 200, which are open to the respective edges of plate 82. Although only a single such recess 218 is shown in the drawings, it will be apparent the multiple recesses may be provided within the ends of the plate. The alignment of the respective recesses permits them to overlap between adjacent links to form a vent 216. The innermost portion of recess 218 within the shelf slopes forwardly in the downward direction. The sloping wall of recess 218, combined with the chamfering or bevelling of the end walls 212 and 214 of the plate, result in the vent having a smaller diameter when the adjacent links are in a planar relationship, while effectively expanding in diameter as the links pivot relative to each other during their passage around the rollers, so as to permit self-cleaning.

Opposing sides 207 and 209 are configured to overlap each other, wherein side 207 includes a recessed portion and side 209 includes a matching projecting portion.

In the structures as described above, the upper surface 82 of the links is essentially the only component exposed directly to the high temperatures, direct flame impingement and reducing environment within the combustion chamber. The links are cooled by the gases flowing through the vents, which form essentially the sole escape opening for the combustion gases supplied to the plenums.

In operation, the system is controlled to deliver a predetermined supply of fuel onto the chain grate at the forward end of the combustion chamber. The substantially solid surface of the grate permits an even distribution of the fuel bed. The fuel bed is minimally disturbed as the grate 30 moves through the combustion chamber. The belt rollers 32 and fuel supply may be controlled to move the grate in a pulsed fashion by an operator, to pause each row of links such that the respective openings are aligned. In this fashion, combustion gas may be pulsed to the bed by the simple expedient of pulsing the travel of the belt while maintaining a constant gas delivery. Alternatively, a similar pulsing effect may be achieve by operating the system in a continuous drive and feed manner at a predetermined rate that provides the desired combustion characteristics.

According to another aspect, after the fuel is deposited upon the grate, each piece of fuel may remain essentially mechanically untouched and unmoved until it is essentially fully combusted into ash. It is believed that this may be achieved by permitting the fuel bed to remain undisturbed and bringing the combustion air to the fuel using the above system wherein each link has its own air injection port and the entire grate effectively comprises an air distribution plenum.

It will be seen by those skilled in the art that the detailed description presented above represented merely an illustrative embodiment of the present invention, and is not intended to limit the scope of the invention in any respect. The full scope of this invention is described within the specification as a whole including the claims. It will be further apparent that certain terms in this specification may bear an extending meaning, wherein those skilled in the art will understand that substitutions of equivalent elements may be made without substantially changing the nature and essence of the invention. All such equivalents are included within the scope of this invention.

What is claimed is:

1. A chain grate for a combustion system, comprising a continuous belt of connected links wherein said links each have a generally boxlike configuration open to below and comprise a substantially solid upper surface, and at least one downwardly projecting wall; at least some of said links comprise at least one vent open to said surface; said grate comprising an array of substantially isolated cells open to below and a substantially continuous upper surface defined by said links; wherein said vents permit combustion gas to travel from the interior of said cells to said surface.

2. A chain grate as defined in claim 1 wherein said links further comprise hinge members for connecting said links in end-to-end relationship, and said vent comprises an opening within at least one of said hinge members, said vent being configured to expand in diameter when adjacent links are disposed in a non-planar relationship.

3. A chain grate as defined in claim 2 wherein said hinge members comprise a hinge block at a first end of said link member and a pair of spaced apart protrusions at a second end of said link member, wherein said hinge block of a first link is configured to fit between and pivotally engage the spaced apart protrusions of a second link, wherein said opening comprises a groove within said hinge block, said upper surface comprising a notch within an edge thereof, wherein said groove and notch within adjacent connected links align to form said vent when said links are in a planar relationship.

4. A chain grate as defined in claim 3 wherein said at least one wall comprises spaced apart side walls on opposing sides of said link and said hinge block extends between said side walls, wherein said cell is defined by said side walls and said hinge blocks.

5. A chain grate as defined in claim 3 wherein said notch and recess are configured to diverge out of alignment when said links are in a non-planar relationship so as to expand the diameter of said vent.

6. A chain grate as defined in claim 3 wherein said hinge block comprises opposed pins protruding laterally from end walls of block and said spaced apart protrusions comprise opposed recesses to pivotally engage said pins.

7. A chain grate as defined in claim 1 wherein said links are configured to partially overlap each other when in side-by-side relationship, said chain grate comprising a plurality of said continuous belts.

8. A link for a chain grate for a combustion system comprising a generally boxlike configuration open to below defined by front and rear ends, and a substantially solid upper surface, at least one vent open to said surface, at least one downwardly projecting wall, and hinge members at said front and rear ends, wherein a plurality of said links may be pivotally connected in end to end relationship by said hinge members and when connected, said links define a plurality of cells open to below and a substantially continuous upper surface wherein said vents permit combustion fluid to travel from the interior of said cells to said surface.

9. A link as defined in claim 8 wherein said vent comprises an opening within at least one of said hinge members, said vent being configured to expand in diameter when adjacent of said links are disposed in a non-planar relationship.

10. A link as defined in claim 8 wherein said hinge members comprise a hinge block at the first end of said link and a pair of spaced apart protrusions at the second end of said link, wherein said block is configured to fit between and pivotally engage the spaced apart protrusions of an adjacent link.

11. A link as defined in claim 10, wherein said hinge block includes a groove and said upper surface comprising a notch within an edge thereof, wherein said groove and notch within adjacent connected links are aligned to form said vent when said links are in a planar relationship, said notch and recess being configured to diverge out of alignment when said links are in a non-planar relationship.

12. A link as defined in claim 10 wherein said hinge block comprises opposed pins protruding laterally from said block, and said spaced apart protrusions comprise recesses to pivotally engage said pins.

13. A system for combustion of a fuel, comprising a frame, first and second rollers mounted to said frame journalled for rotation relative to said frame mounted in a spaced apart relationship to define a combustion zone there-between, a chain grate as defined in claim 1 mounted for rotation between said rollers, a horizontal bed between said rollers, drive means to drive said grate, and at least one source of combustion fluid, said bed comprising a flat surface for supporting said chain grate, at least one internal plenum for distribution of said combustion fluid, and an array of openings for discharge of said fluid from said plenum through the vents in said chain grate when said vents and openings are aligned, wherein when said chain grate is supported by said bed, said cells are substantially enclosed and isolated from each other.

14. A system as defined in claim 13 wherein said at least one plenum is configured to define a plurality of zones for providing said combustion fluids with different properties or parameters in different locations in said bed.

15. A system as defined in claim 14 comprising a plurality of said plenums defined by at least one internal baffle within said bed, said zones being defined by said plurality of plenums.

16. A method as defined in claim 14 wherein said parameters comprise varying mixtures of recirculated combustion chamber gas and outside air.

17. A system as defined in claim 13 wherein said flat surface of said bed comprises a continuous array of tiles, at least some of said tiles having generally vertical grooves within at least one side wall thereof to form said openings, said tiles being adapted to permit said chain grate to slide across said array.

18. A system as defined in claim 13 comprising means for controlling the supply of combustion fluid delivered to said fuel by controlling the movement of said chain grate across said bed, wherein said fluid is delivered to said fuel only when the vents in said chain grate are aligned with the openings in said bed and the movement of said chain grate defines the sequence and timing of openings and closings of said vents.

19. A system as defined in claim 13 which is configured to permit said fuel to remain essentially mechanically untouched and unmoved until it is essentially fully combusted into ash.
